(19) United States
(12) Patent Application Publication
(10) Pub. No.: US 2015/0047408 A1
(43) Pub. Date: Feb. 19, 2015

(54) BALER TOOTH STRAIGHTENING SYSTEM

(71) Applicant: Ray Jacobson, Baldwin, ND (US)

(72) Inventor: Ray Jacobson, Baldwin, ND (US)

(21) Appl. No.: 13/965,925

(22) Filed: Aug. 13, 2013

(51) Int. Cl. B21D 3/16; A01D 89/00

(52) U.S. Cl. CPC B21D 3/16; A01D 89/006
USPC 72/372; 72/419

(57) ABSTRACT

A system and method for straightening a bent tine of a baler tooth includes a holding member having a narrow opening for temporarily inserting a first section of the bent tine between a bend in the bent tine and a tooth coil of the baler tooth and for firmly gripping the first section of the bent tine to be straightened. Also, a straightening member having a narrow opening for temporarily inserting a second section of the bent tine between the bend in the bent tine and a free end of the bent tine and for straightening the second section of the bent tine while the first section is firmly gripped by the holding member.

### FIELD OF THE INVENTION

The present invention is directed to a system for straightening a bent tine of a baler tooth and more particularly to a holding member for gripping the bent tine between a bend, and a straightening member for straightening the bent tine.

### BACKGROUND OF THE INVENTION

In recent years, there is increasing interest in hay as a useful and potentially economical means of feeding cattle in locations throughout the United States and the world. Further, straw, which used to be merely burned in the fields, is also recognized as a very useful commodity and has a number of uses, such as insulation. One of the primary inhibitors to effectively utilizing the advantages of hay and straw is the current inability to efficiently ship it over large distances, particularly to locations where hay and straw cannot be effectively grown.

Hay and straw are generally harvested and packed into bales, as is a number of other types of forage of fiber content, such as alfalfa. These bales are formed by hay balers which often form a large bale from individual capsules of hay that are compressed and combined to form the complete bale. Several different types of balers are commonly used, each producing a different type of bales—rectangular or cylindrical, of various sizes, bound with twine, strapping, netting, or wire.

### SUMMARY OF THE INVENTION

According to the present invention, a system for straightening a bent tine of a baler tooth includes a holding member having a narrow opening for temporarily inserting a first section of the bent tine between a bend in the bent tine and a tooth coil of the baler tooth and for firmly gripping the first section of the bent tine to be straightened. Also, a straightening member having a narrow opening for temporarily inserting a second section of the bent tine between the bend in the bent tine and a free end of the bent tine and for straightening the second section of the bent tine while the first section is firmly gripped by the holding member.

Further according to the present invention, a method of straightening a bent tine of a baler tooth includes: temporarily inserting a first section of the bent tine between a bend in the bent tine and a tooth coil of the baler tooth into a first narrow opening in a holding member; firmly gripping the first section of the bent tine to be straightened with the holding member; temporarily inserting a second section of the bent tine between the bend in the bent tine and a free end of the bent tine into a first narrow opening in a straightening member; and moving the straightening member with respect to the holding member while the first section is firmly gripped by the holding member for aligning the first and second sections of the bent tine whereby the bend is substantially removed from the bent tine.

Further according to the present invention, a system for straightening a bent wire includes a holding member having a narrow opening to temporarily insert a first section of the bent wire and to firmly grip the first section of the bent wire to be straightened. Also, a straightening member having a narrow opening for temporarily inserting a second section of the bent wire and for straightening the second section of the bent wire while the first section is firmly gripped by the holding member.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front perspective view of the baler tooth straightening system in use, in accordance with the present invention.

FIG. 2 is a front perspective view of the baler tooth straightening system in use, in accordance with the present invention.

FIG. 3 is a front perspective view of the holding member of the baler tooth straightening system, in accordance with the present invention.

FIG. 4 is a front perspective view of the straightening member of the baler tooth straightening system, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

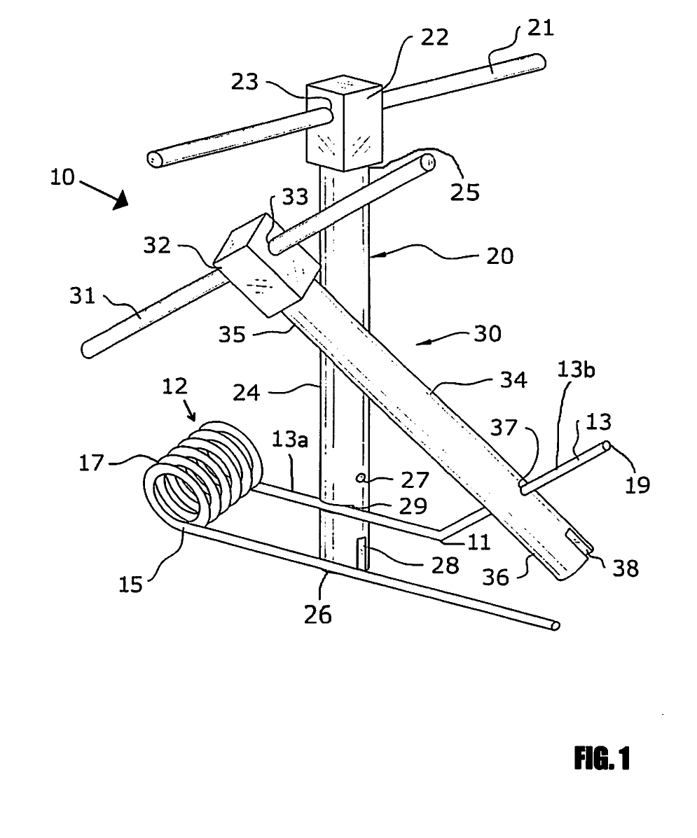

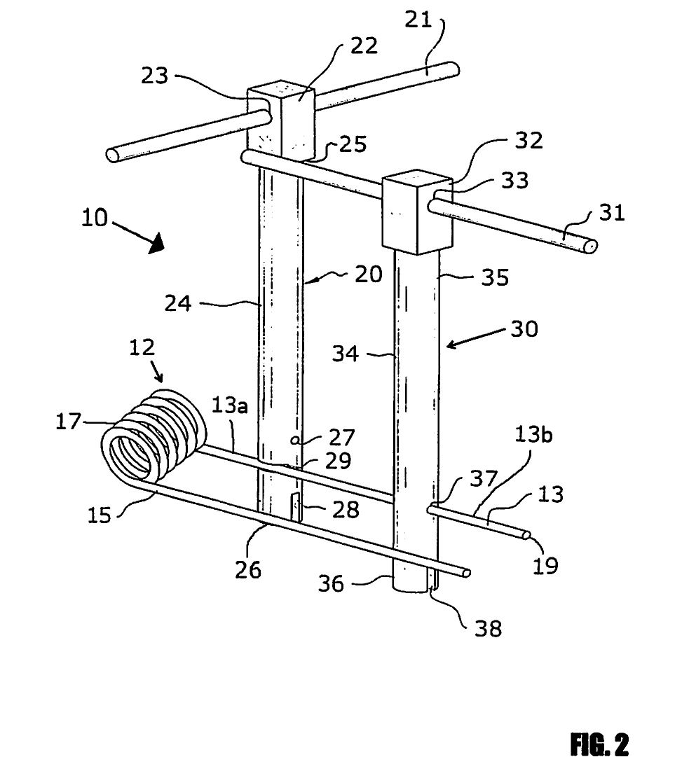

A hay baler is a piece of farm machinery used to compress a cut and raked crop, such as hay, cotton, straw, or silage, into compact bales that are easy to handle, transport, and store. Hay balers commonly utilize a plurality of baler teeth that contain tines that may bend or otherwise have their shape distorted, rendering the hay baler inefficient or inoperable. The baler tooth straightening system 10 (hereafter “straightening system”), as shown in FIGS. 1 and 2, is a response to this problem and enables the tines 13 and 15 of the baler tooth 12 to be straightened while still mounted to a hay baler (not shown).

In general terms, the straightening system 10, as shown in FIG. 1 and FIG. 2, includes a holding member 20 and a straightening member 30. The holding member 20 has a narrow opening such as a bore 27, vertical slot 28 and horizontal slot 29, or any combination thereof, to temporarily insert a first section 13a of the bent tine 13 between a bend 11 in the bent tine and a tooth coil 17 of the baler tooth and to firmly grip the first section of the bent tine to be straightened. Further, the straightening system 10 includes a straightening member 30 having a narrow opening such as a bore 37, or a vertical slot 38, or any combination thereof, to temporarily insert a second section 13b of the bent tine 13 between the bend 11 in the bent tine and a free end 19 of the bent tine and to straighten the second section of the bent tine while the first section 13a is firmly gripped by the holding member 20.

It is within the terms of the embodiment that the straightening system 10 be used with a bent wire (not shown), similar to the tine 13. While the preferred embodiment has been described with respect to straightening a tine 13, it is also within the scope of the preferred embodiment to straighten any wire.

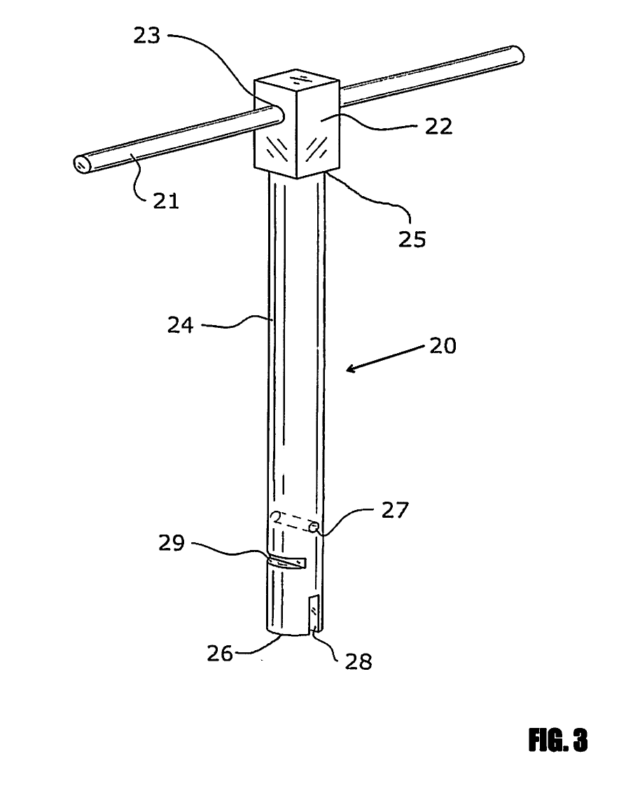

FIG. 3 illustrates a front perspective view of the holding member 20 for securing the bent tine 13 of the baler tooth 12 while it is being straightened by the straightening member 30 (as seen in FIGS. 1 and 2). The holding member 20 will generally be comprised of a generally T-shaped structure, though it is appreciated that various other shapes may be utilized. The holding member 20 is preferably constructed of a durable, metallic material which will not be susceptible to rust. However, it is within the terms of the embodiment that various materials may be utilized for the holding member 20, such as a plastic polymer, so long as it exhibits the structural strength needed for holding the tine 13 of the baler tooth 12 it is being straightened by the straightening member 30.

The holding member 20 will generally include a handle 21, a connection member 22 and an elongated rod 24. The handle 21 will generally be comprised of a rod or other elongated member which extends perpendicularly with respect to the elongated rod 24. While the handle 21 is shown in the figures as having a circular cross-section, it is appreciated that various other cross-sections may be utilized.

The connection member 22 is comprised of a structure that links the elongated rod 24 with the handle 21 of the holding member 20. The connection member 22 is comprised of a structure which is fixedly attached to the upper end 25 of the elongated rod 24. In a preferred embodiment, the connection member 22 will be comprised of a cube-shaped connector member having a connection through bore 23 extending therethrough. The handle 21 will preferably be slidably attached to the connection member 22 through the connection through bore 23. It is also within the terms of the embodiment that the handle 21 be integrally formed with the connection member 22 and/or the elongated rod 24.

The elongated rod 24 will be comprised of an elongated member which extends downward from the connection member 22. The elongated rod 24 includes an upper end 25 and a lower end 26, wherein the upper end 25 of the elongated rod 24 is fixedly attached to the connection member 22 or, alternatively directly to the handle 21. While the size of the elongated rod 24 and holding member 20 may vary to accommodate different applications or operators, it is preferable that the holding member 20 be approximately 6 to 12 inches long and preferably 9 inches long. Further, the elongated rod 24 may be comprised of various materials and include various cross-sections without affecting the overall operation of the straightening system 10.

The holding member 20 also includes a bore 27 extending there through, a vertical slot 28, and horizontal slot 29 for use in securing the tine 13 of the baler tooth 12 in a locked down position while straightening the tine 13 with the straightening member 30 (as seen in FIGS. 1 and 2). The bore 27 is comprised of a through bore which extends through the elongated rod 24. The bore 27 can have a cross section that is circular or of any desired shape such square, rectangular or octagonal and will preferably be of a large enough size to accommodate the insertion of various sized and shaped tines 13 therethrough. While the bore 27 may be positioned at various locations along the elongated rod 24, it is within the terms of the preferred embodiment that the bore 27 be positioned approximately a quarter of the way up the length of the rod 24 from the bottom end 26 for ease of use of the straightening system 10.

The vertical slot 28 and horizontal slot 29 of the elongated rod 24 are utilized to provide additional structures for holding and securing the tine 13 of the baler tooth 12 as it is being straightened. The vertical slot 28 will preferably be comprised of a slot extending upward into the elongated rod 24 from the bottom end 26.

While the horizontal slot 29 will preferably be comprised of a slot which extends partially into the side of the elongated rod 24 and between the vertical slot 28 and the bore 27, it is within the terms of the preferred embodiment to position the horizontal slot 29 above the bore 27.

The vertical slot 28 and horizontal slot 29 can be of any desired size to accommodate the insertion of various sized and shaped tines 13 therein.

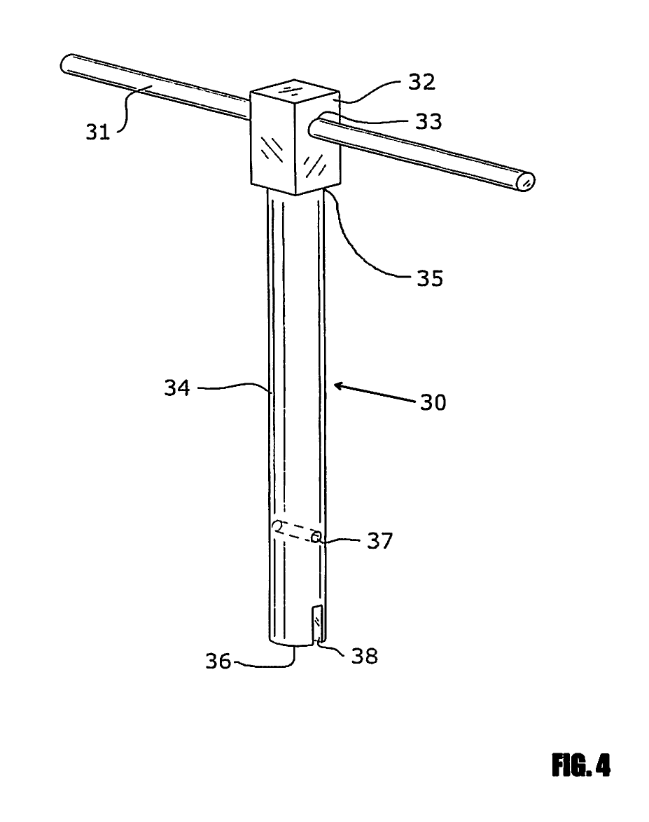

FIG. 4 illustrates a front perspective view of the straightening member 30 for securing the tine 13 of the baler tooth 12 while it is being held by the holding member 20 (as seen in FIGS. 1 and 2). The straightening member 30 will generally be comprised of a T-shaped structure, though it is within the terms of the embodiment that various other shapes may be utilized. The straightening member 30 will preferably be comprised of a durable, metallic material which will not be susceptible to rust. However, it is appreciated that various materials may be utilized for the straightening member 30, such as a plastic polymer, so long as it exhibits the structural strength needed for straightening the tine 13 of the baler tooth 12 while it is being held by the holding member 20.

As shown in FIG. 4, the straightening member 30 includes a handle 31, a connection member 32 and an elongated rod 34. The handle 31 is comprised of a rod or other elongated member which extends perpendicularly with respect to the elongated rod 34. While the handle 31 is shown in the figures as having a circular cross-section, it is appreciated that various other cross-sections may be utilized.

The connection member 32 is comprised of a structure which links the elongated rod 34 of the straightening member 30 with the handle 31 of the straightening member 30. The connection member 32 will be comprised of a structure which is fixedly attached to the upper end 35 of the elongated rod 34. In a preferred embodiment, the connection member 32 will be comprised of a cube-shaped connector having a connection through bore 33 extending therethrough. The handle 31 will preferably be slidably attached to the connection member 32 through the connection through bore 33. It is also within the terms of the embodiment that the handle 31 be integrally formed with the connection member 32 and/or the elongated rod 34.

The elongated rod 34 is comprised of an elongated member which extends outward from the connection member 32. The elongated rod 34 includes an upper end 35 and a lower end 36, wherein the upper end 35 of the elongated rod 34 is fixedly attached to the connection member 32 or, alternatively directly to the handle 31. While the size of the elongated rod 34 and straightening member 30 may vary to accommodate different applications or operators, it is within the terms of the preferred embodiment that the straightening member 30 be approximately 6 to 12 inches long and 8 inches long, such that it is slightly shorter than the holding member 20. Also, the elongated rod 34 may be comprised of various materials and include various cross-sections without affecting the overall operation of the straightening system 10.

The straightening member 30 also includes a bore 37 and a vertical slot 38 for use in straightening the tine 13 of the baler tooth 12, while the tine 13 is being secured by the holding member 20 (as seen in FIGS. 1 and 2). The bore 37 is comprised of a through bore through the elongated rod 34. As with the through bore 27, bore 37 can have a cross section that is circular or of any desired shape such square, rectangular or octagonal and will preferably be of a large enough size to accommodate the insertion of various sized and shaped tines 13 therethrough.

While the bore 37 may be positioned at various locations on the elongated rod 34, it is preferable that the bore 37 be positioned approximately a quarter of the way up the rod 34 from the end 36 for ease of use of the straightening system 10.

The vertical slot 38 of the straightening member 30 is generally utilized to provide an additional structure for holding and securing the tine 13 of the baler tooth 12 as it is being straightened. The vertical slot 38 will preferably be comprised of a slot extending upward into the elongated rod 34 from the bottom end 36. As with the vertical slot 28, the vertical slot 38 can be of any desired size to accommodate the insertion of various sized and shaped tines 13 therein.

FIGS. 1 and 2 illustrate the straightening system 10 in use. As seen in FIG. 1, the method includes temporarily inserting a first section 13a of the bent tine 13 between a bend 11 in the bent tine and a tooth coil 17 of the baler tooth 12 into a first narrow opening, such as horizontal slot 29 of the holding member 20. It should be noted that the bent tine 13 may also be temporarily inserted through the bore 27 or the vertical slot 28. The holding member 20 firmly grips the first section 13a of the bent tine 13 to be straightened with the holding member.

The method further includes temporarily inserting a second section 13b of the bent tine 13 between the bend 11 in the bent tine and a free end 19 of the bent tine into a first narrow opening, such as bore 37, in the straightening member 30. It should be noted that the bent tine 13 may also be temporarily inserted through the vertical slot 38. The method further includes straightening the second section 13b of the bent tine 13 by moving the straightening member 30 with respect to the holding member 20 while the first section 13a is firmly gripped by the holding member.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A system for straightening a bent tine of a baler tooth, comprising:
a holding member having a narrow opening for temporarily inserting a first section of the bent tine between a bend in the bent tine and a tooth coil of the baler tooth and for firmly gripping the first section of the bent tine to be straightened; and
a straightening member having a narrow opening for temporarily inserting a second section of the bent tine between the bend in the bent tine and a free end of the bent tine and for straightening the second section of the bent tine while the first section is firmly gripped by the holding member.

2. The baler tooth straightening system of claim 1 wherein:
the holding member is comprised of an elongated rod having a handle mounted to a first end of the elongated rod.

3. The baler tooth straightening system of claim 1 wherein:
the straightening member is comprised of an elongated rod having a handle mounted to a first end of the elongated rod.

4. The baler tooth straightening system of claim 2 wherein the narrow opening in the holding member is a through bore extending through the elongated rod.

5. The baler tooth straightening system of claim 2 wherein the narrow opening in the holding member is a vertical slot extending upward into the elongated rod from a bottom end of the elongated rod.

6. The baler tooth straightening system of claim 2 wherein the narrow opening in the holding member is a slot which extends partially into a side of the elongated rod.

7. The baler tooth straightening system of claim 2 wherein the elongated rod of the holding member includes a plurality of narrow openings comprising:
a through bore extending through the elongated rod;
a vertical slot extending upward into the elongated rod from a bottom end of the elongated rod; and
a slot which extends partially into a side of the elongated rod.

8. The baler tooth straightening system of claim 3 wherein the narrow opening in the straightening member is a through bore extending through the elongated rod.

9. The baler tooth straightening system of claim 3 wherein the narrow opening in the straightening member is a vertical slot extending upward into the elongated rod from a bottom end of the elongated rod.

10. The baler tooth straightening system of claim 3 wherein the elongated rod of the straightening member includes a plurality of narrow openings comprising:
a through bore extending through the elongated rod; and
a vertical slot extending upward into the elongated rod from a bottom end of the elongated rod.

11. The baler tooth straightening system of claim 1 wherein:
the baler tooth having a bent tine is mounted by the tooth coil of the baler tooth to a baler machine.

12. A method of straightening a bent tine of a baler tooth, comprising:
temporarily inserting a first section of the bent tine between a bend in the bent tine and a tooth coil of the baler tooth into a first narrow opening in a holding member;
firmly gripping the first section of the bent tine to be straightened with the holding member;
temporarily inserting a second section of the bent tine between the bend in the bent tine and a free end of the bent tine into a first narrow opening in a straightening member; and
moving the straightening member with respect to the holding member while the first section is firmly gripped by the holding member for aligning the first and second sections of the bent tine whereby the bend is substantially removed from the bent tine.

13. The method of claim 12, further including providing the mounting member having an elongated rod with a handle mounted to a first end of the elongated rod.

14. The method of claim 12, further including providing the straightening member having an elongated rod with a handle mounted to a first end of the elongated rod.

15. The method of claim 13, further including providing the elongated rod of the holding member with a plurality of narrow openings comprising:
providing a through bore extending through the elongated rod;
providing a vertical slot extending upward into the elongated rod from a bottom end of the elongated rod; and
providing a slot which extends partially into a side of the elongated rod.

16. The method of claim 14, further including providing the elongated rod of the straightening member with a plurality of narrow openings comprising:
providing a through bore extending through the elongated rod; and
providing a vertical slot extending upward into the elongated rod from a bottom end of the elongated rod.

17. The method of claim 12, further including straightening the bent tine of the baler tooth while the baler tooth is mounted to a baler machine.

18. A system for straightening a bent wire, comprising:
a holding member having a narrow opening to temporarily insert a first section of the bent wire and to firmly grip the first section of the bent wire to be straightened; and
a straightening member having a narrow opening for temporarily inserting a second section of the bent wire and for straightening the second section of the bent wire while the first section is firmly gripped by the holding member.

19. The wire straightening system of claim 18 wherein:
the holding member and the straightening member are each comprised of an elongated rod having a handle mounted to a first end of the elongated rod.

20. The wire straightening system of claim 19 wherein each elongated rod of includes a plurality of narrow openings comprising:
a through bore extending through each elongated rod; and
a vertical slot extending upward into each elongated rod from a bottom end of each of the elongated rods.
